(19) United States
(12) Patent Application Publication
(10) Pub. No.: US 2006/0179421 A1
(43) Pub. Date: Aug. 10, 2006

(54) Dynamic interface binding using XML transformations

(75) Inventors: Julianne Bielski, Durham, NC (US); Michael David Day II, Cary, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/054,393

(22) Filed: Feb. 9, 2005

(51) Int. Cl. G06F 9/44

(52) U.S. Cl. 717/115

(57) ABSTRACT

An improved Extensible Style Language Transformations (XSLT) processor adapts to dynamic environmental conditions of a target platform on which the XSLT processor operates. Based on the dynamic environment condition(s) of the target platform, the XSLT processor, using an Extensible Markup Language—Remote Procedure Calling (XML-RPC) source document and an Extensible Style Language (XSL) stylesheet, generates customized script that accomplishes the directive of the XML-RPC source document.

### BACKGROUND OF THE INVENTION

1. Technical Field

The present invention relates in general to the field of computer software, and in particular to Extended Markup Language (XML) data transformations. Still more particularly, the present invention relates to an XML data transformation technique that allows the dynamic generation of software components based on runtime factors, such as environmental conditions, policy, and other dynamic characteristics, of a target platform.

2. Description of the Related Art

Interface binding, or the process of linking discrete software components together using predefined interfaces, is critical to every aspect of software development. Interface binding usually involves predefined and unambiguous interface definitions. The interface definitions represent a contract between a first software component (the caller) and a second software component (the callee). This contract specifies the format and behavior of the interface in unambiguous terms. Once specified, the interface must comply with its contract, which means that the interface cannot change, either in definition or behavior.

The modularity of a software component frequently depends upon the nature of its interface binding technology. Generally speaking, the longer a software component can delay binding to the interfaces of another software component, the more modular that software component can be. “Late binding” is the term used to describe the technique of postponing of interfaced binding to the last possible instant.

One common interface binding is described in the “XML-RPC Specification”, by Dave Winer, published by UserLand Software, Inc., Jun. 15, 1999, which is herein incorporated by reference in its entirety. XML-RPC, which stands for “Extensible Markup Language—Remote Procedure Calling,” is a specification and set of implementations that allow software running on disparate operating systems on two separate computers to exchange procedure calls over the Internet. HyperText Markup Language (HTML) is used to transport the calls, and Extensible Markup Language (XML) is used to encode the call at each of the two computers.

Although XML-RPC is able to communicate across different operating systems, XML-RPC is confined to responses that are fixed according to the (HTML-XML) interface between the two XML engines. That is, although XML-RPC allows a first computer system to evoke a procedure call on a second disparate computer system, XML-RPC alone does describe a call procedure that is based on dynamic factors, such as environmental conditions (e.g., temperature, device status, load, etc. in the computer), policy (business logic, identity, service level agreement), or other dynamic characteristics of second disparate computer system.

What is needed, therefore, is a method for tailoring which procedure call (or other software component) is made on a second computer system by a first computer system, such that the procedure call is determined by dynamic factors, such as environmental conditions, policy, or other dynamic characteristics of second disparate computer system.

### SUMMARY OF THE INVENTION

The present invention is thus directed to an improved Extensible Style Language Transformations (XSLT) processor that adapts to dynamic environmental conditions of a target platform on which the XSLT processor operates. Based on the dynamic environment condition(s) of the target platform, the XSLT processor, using an Extensible Markup Language—Remote Procedure Calling (XML-RPC) source document and an Extensible Style Language (XSL) stylesheet, generates customized script that accomplishes the directive of the XML-RPC source document.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIGS. 1a-b depict a prior art conversion of an XML document into an HTML document;

FIGS. 2a-b illustrate the present invention's use of a modified XSLT processor to create script from an XML source document and an XSL stylesheet based on current environmental/dynamic conditions of a target platform;

FIG. 3 depicts a process in which an XML-RPC response document can be generated;

FIG. 4 illustrates the use of the present invention to generate binary executable code;

FIGS. 5 and 6 depict the use of the modified XSL processor to select which XSL stylesheet to use with an XML-RPC source document; and

FIG. 7 illustrates an exemplary computer system in which the present invention can be implemented.

### DETAILED DESCRIPTION OF THE PREFERRED EMBODIMENT

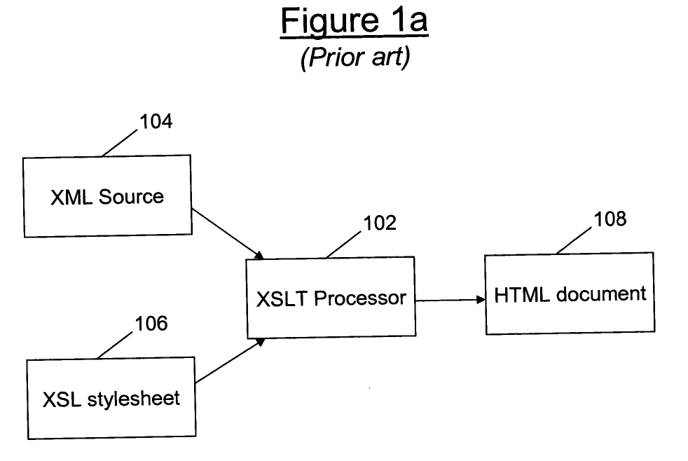

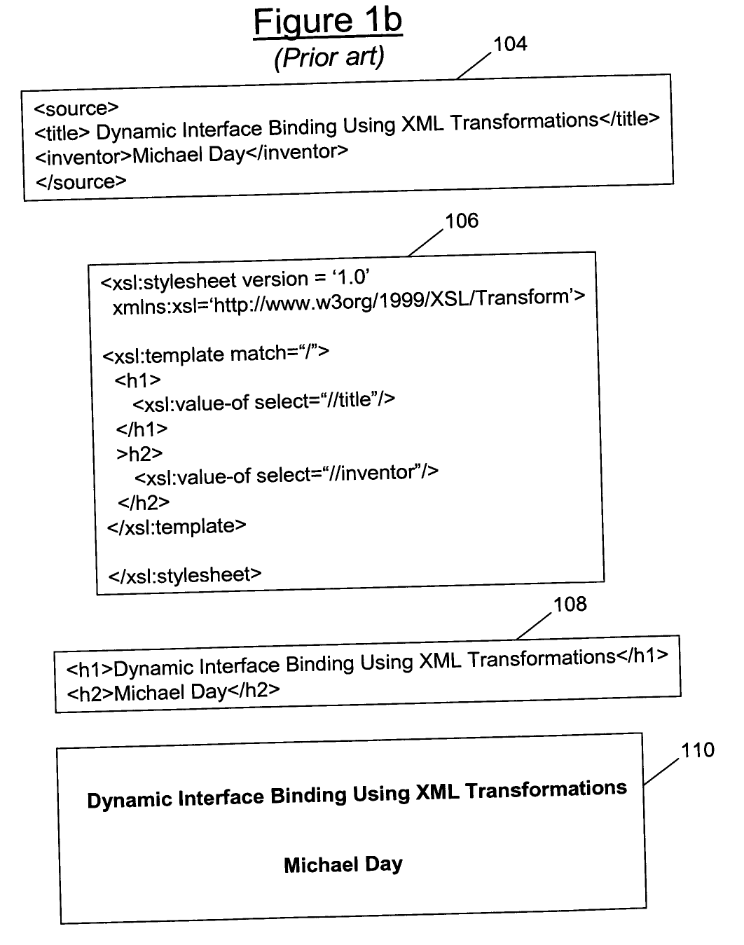

With reference now to the figures, and in particular to FIG. 1a, a block diagram of a prior art transformation process using an XSLT processor 102 is shown. XSLT processor 102 combines information from an XML source 104 and an XSL stylesheet 106 to create an HTML document 108.

HTML is an authoring language used to create documents on the World Wide Web. HTML defines the structure and layout of a Web document by using a variety of tags and attributes. (Incorporated by reference herein in its entirety is the HTML specification found in “HTML 4.01 Specification W3C Recommendation 24 Dec. 1999”, published by the World Wide Web Consortium (W3C).)

Both a strength and limitation of HTML are that HTML uses a fixed set of concepts (such as paragraphs, lists, and tables) to create a webpage. Thus, the elements in HTML are essentially typographic. While this feature is useful in creating unambiguous code, it is often not “real world” friendly.

A language that is very “real world” and user friendly is the Extensible Markup Language (XML), which was defined in early 1998. (Incorporated by reference herein in its entirety is the XML specification found in Extensible Markup Language (XML) 1.0 (Third Edition), W3C Recommendation, 4 Feb. 2004, Francois Yergeau, Tim Bray, Jean Paoli, C. M. Sperberg-McQueen, Eve Male.)

XML is a markup language used to represent structured content independent of its presentation. Specifically, XML describes a class of data objects called XML documents. XML documents are made up of storage units called entities, which contain either parsed or unparsed data. Parsed data is made up of characters, some of which form character data, and some of which form markup. Markup encodes a description of the document's storage layout and logical structure. and partially describes the behavior of computer programs which process them.

Unlike HTML, the tags used in XML markup are entirely user defined, with the intention being that these tags should relate to objects in the domain of interest (such as people, places, prices, and dates). This flexibility creates problems in displaying content, however, since there is a lack of fixed formatting instruction in an XML document.

To allow an XML document to be visually displayed using HTML, there must be an interface binding between the XML document and the HTML document. This interface binding occurs in two steps: transformation and formatting. That is, the XML document must first be transformed into an HTML document, which can then be formatted by an HTML browser (formatting engine). A language that has been developed to transform the XML document into HTML is the Extensible Style Language Transformations (XSLT) language, which was developed by the World Wide Web Consortium (W3C) and published as a Recommendation specification on Nov. 16, 1999. (XSL Transformations (XSLT), Version 1.0, published as W3C Recommendation 16 Nov. 1999, James Clark, Editor, and available at http://www.w3.org/TR/1999/REC-xslt-19991116, is herein incorporated by reference in its entirety.)

With reference now to FIG. 1b, there is depicted pseudocode used by and results of the process shown in FIG. 1a. XML source 104 provides a source of data to be used to populate the HTML document 108. In the example shown, XML source 104 has “Dynamic Interface Binding Using XML Transformations” in a “title” field, and “Michael Day” in an “inventor” field. These fields populate the corresponding fields shown in the XSL stylesheet 106, to create the HTML document 108 as shown. The HTML document 108 is displayed in a Graphical User Interface (GUI) 110 as depicted.

The process described in FIGS. 1a-b requires predefined static interface definitions. Using such static interface definitions, a first software component (XML document) can only integrate with a predefined set of another software component (HTML document), and then only using predefined interactions described in prior art XSLT processors.

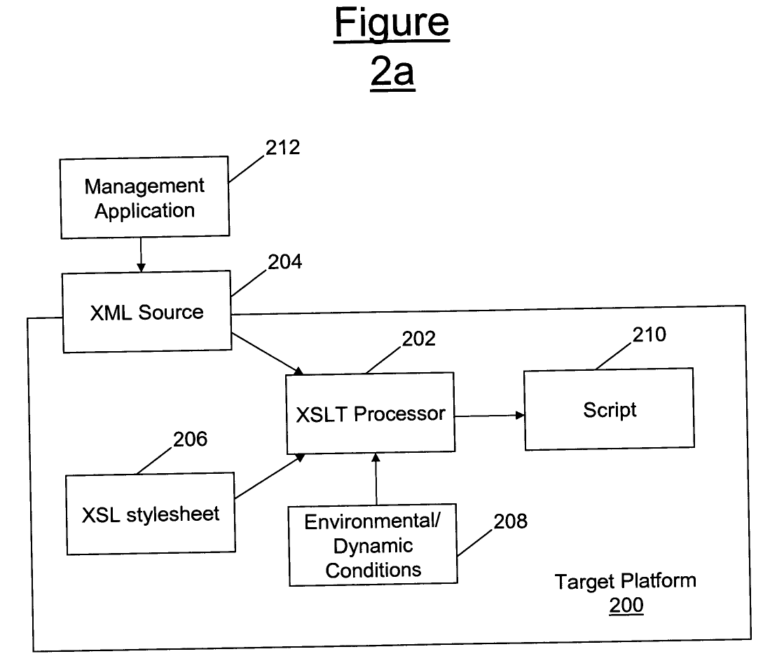

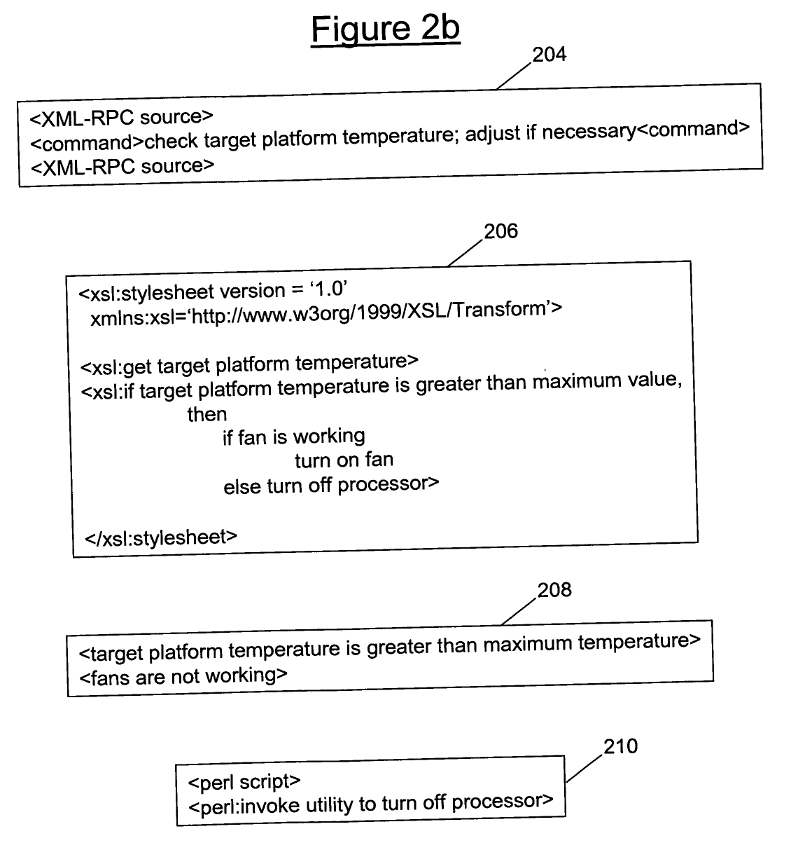

With reference now to FIG. 2a, an overview of the broad concept of the present invention is presented. In a target platform 200 (a specifically hardware-configured computer system running a particular operating system), an improved XSLT processor 202 combines an XML source 204, an XSL stylesheet 206, and one or more dynamic environmental conditions 208 of target platform 200, to generate a script 210. Preferably, the XML source 204 is generated by and transmitted from a management application 212, such as a remote manager. In a preferred embodiment, XML source 204 is an XML-RPC source document. It is significant to note the following items.

First, the dynamic environmental conditions 208 may be either software or hardware in the target platform 208 (computer system). That is, dynamic environmental condition 208 is defined as environmental conditions such as temperature, device status, load, etc. in the computer system, software policy (business logic, identity, service level agreement), legacy software, or other dynamic characteristics of the computer system. Thus, the present invention can be used to normalize platform management interfaces, integrate legacy platform management interfaces, or to control platforms based on dynamic character4istics of the environment or platform.

Second, script 210 may be any software code, but in a preferred embodiment, as described in detail below, script 210 is a script that calls a particular utility or procedure responsive to the data in the XML source 204.

With reference then to FIG. 2b, an exemplary example of how the components in FIG. 2a may function is shown. For purposes of illustration, assume that XML source 204 is an XML-RPC packet checking on target platform 200 to make sure that target platform 200 is not running too hot. Thus, the XML-RPC pseudocode in XML source 204 shown in FIG. 2b asks if target platform 200 is running too hot, and if so, to take corrective steps. XSL stylesheet 206 shows pseudocode for checking the temperature of target platform 200, and if too hot, either turning on a fan or, if the fan is not working, turning off a processor. Dynamic environmental conditions 208, which is a second XSL stylesheet unless XSLT processor 202 has been modified to accept other direct input of dynamic environmental conditions 208, is called by XSLT processor 202 to run XSL stylesheet 206. Since the fan is broken, as described by dynamic environmental conditions 208, then a Perl script 210 is issued invoking a utility (not shown) in target platform 200 to turn off a processor (also not shown) in target platform 200.

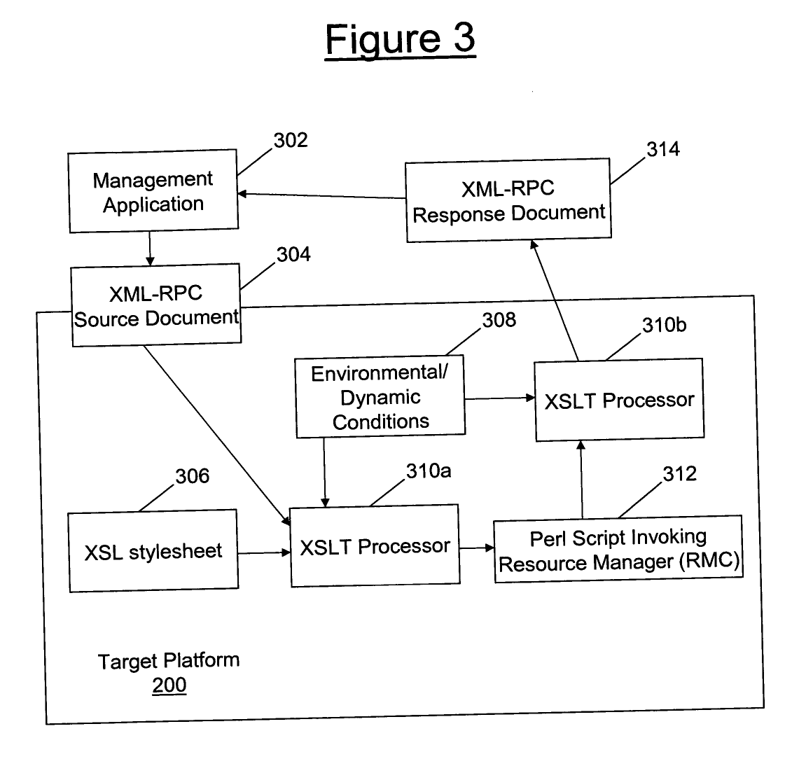

With reference now to FIG. 3, additional steps to those exemplified in FIG. 2a are shown. As in FIG. 2a, a management application 302 sends an XML-RPC source document 304 to a target platform 200. The XML-RPC source document 304, together with an XSL stylesheet 306 and environmental/dynamic conditions 308 (of target platform 200) are processed in XSLT processor 310a to create a Perl script 312 that invokes a resource manager, such as a call to a function that enacts the underlying instruction found in XML-RPC source document 304.

Note that the XML-RPC specification supports feedback. That is, XML-RPC not only allows management application 302 to send instructions via an XML-RPC source document 304 to the XSLT processor 310, but XML-RPC also allows management application 302 to receive an XML-RPC response document 314 that informs management application 302 what actions occurred at target platform 200 in response to the receipt of the XML-RPC source document 304. To generate the XML-RPC response document 314, XSLT processor 310b (which preferably is the same XSLT processor as XSLT processor 310a) transforms the Perl script 312 under directions dictated by the environmental/dynamic conditions 308 of target platform 200, which now include the status of target platform 200 after the action (such as turning off a processor) invoked by Perl script 312. The response document 314 is then sent back to management application 302.

While the example shown in FIG. 3 is relatively simple for illustrative purposes, it demonstrates how the present invention using a new XML-RPC interface can be dynamically bound to an existing software component using only two test files (XML-RPC source document 304 and XSL stylesheet 306) and an XSLT processor 310.

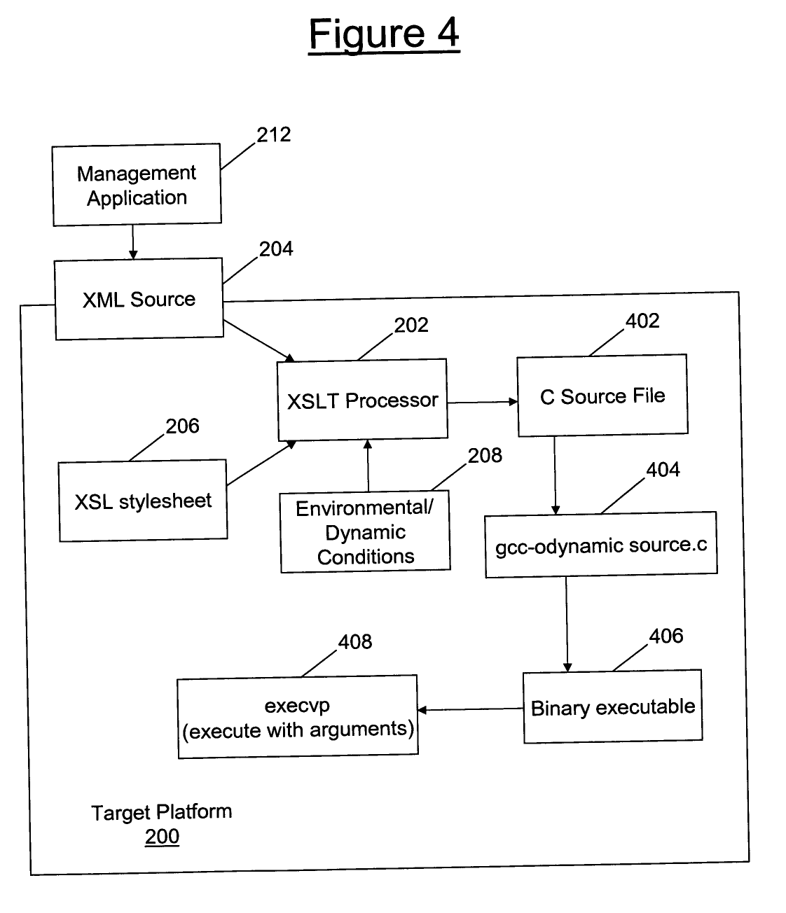

While the invention has been shown in an exemplary manner as creating a Perl script, note that, as shown in FIG. 4, XSLT processor 202 can generate any type of code, including a C Source file 402, which, when fed through a C compiler such as gcc-odynamic source.c 404, can generate binary executable code 406, which can be executed with arguments using the execvp 408 function call.

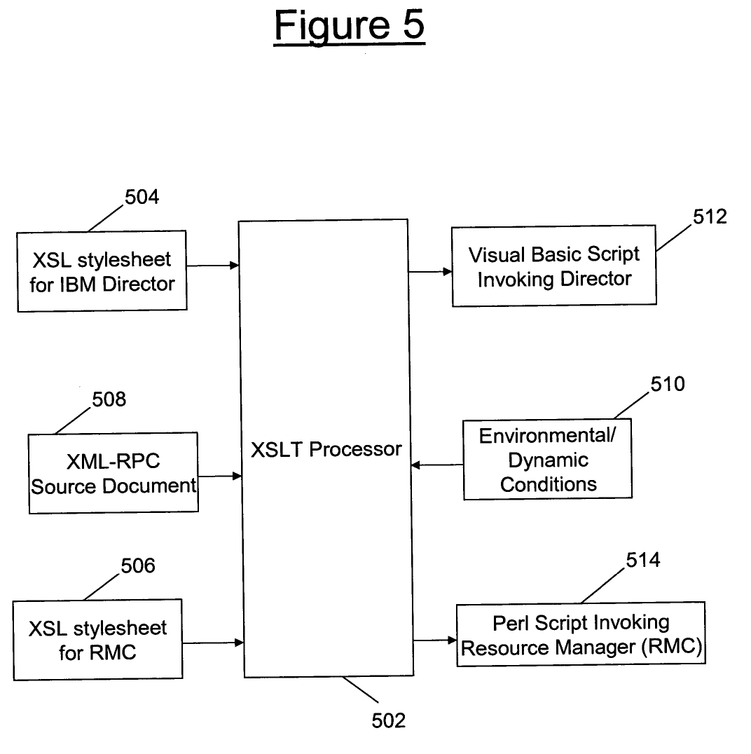

With reference now to FIG. 5, the present invention can also be used to normalize interfaces between legacy applications, such as IBM Director™ and RMC (Resource Management and Control). That is, an XSLT processor 502 can have access to an XSL stylesheet 504 that is unique for IBM Director™ and an XSL stylesheet 506 that is unique for RMC, a multi-platform supporting control application. When an XML-RPC source document 508 is received while under the influence of environmental/dynamic conditions 510 of the target platform (not shown), then the XSLT processor 502 may create either a Visual Basic script 512 that invokes IBM director™ or a Perl script 514 that invokes RMC. That is, the XSLT processor 502 is programmed with intelligence that recognizes, based on the current environmental/dynamic conditions of the target platform, which stylesheet should be used, based on the hardware, operating system, and other features currently on the target platform.

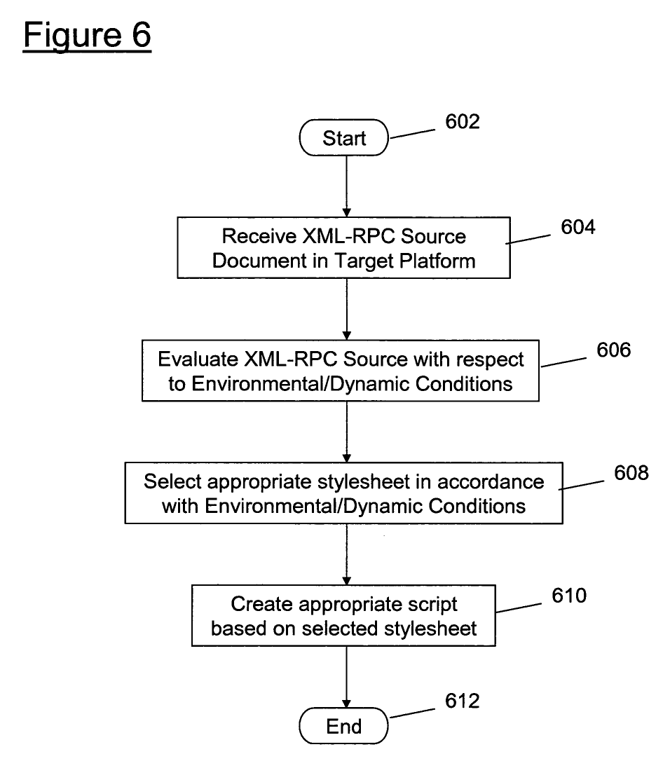

FIG. 6 is a flow chart of exemplary steps taken with the features shown in FIG. 5. After initiator block 602, the target platform receives an XML-RPC source document (block 604). The XML-RPC source document is evaluated by the XSLT processor in light of the current dynamic environmental conditions of the target platform (block 606). In response to this evaluation, the XSLT processor selects the appropriate stylesheet (block 608), creates appropriate script based on the stylesheet that was selected (block 610), and the process ends (terminator block 612).

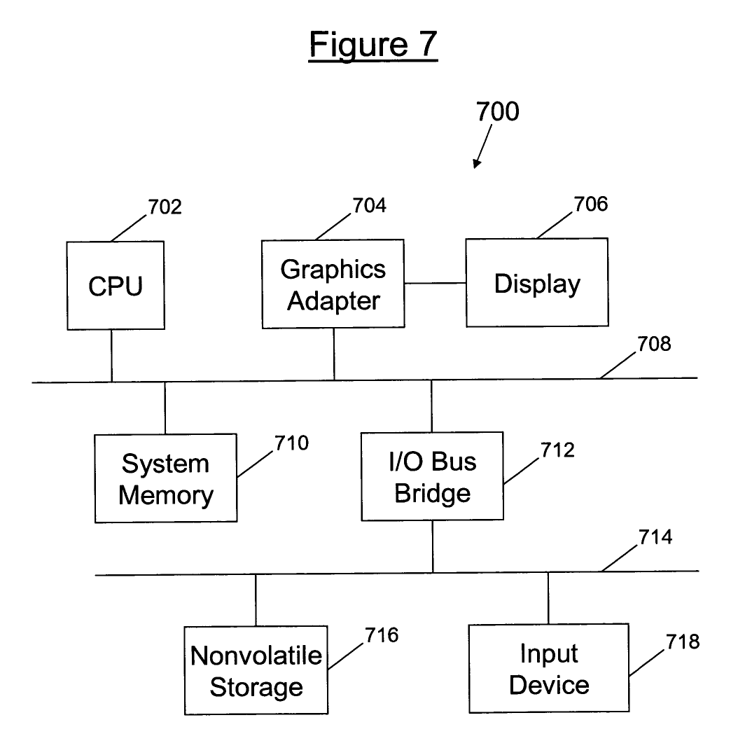

With reference now to FIG. 7, there is depicted a block diagram of a data processing system in which a preferred embodiment of the present invention may be implemented. Data processing system 700 represents an exemplary hardware configuration of a target platform. Data processing system 700 may be, for example, one of the models of personal computers or servers available from International Business Machines Corporation of Armonk, N.Y. Data processing system 700 includes a central processing unit (CPU) 702, which is connected to a system bus 708. In the exemplary embodiment, data processing system 700 includes a graphics adapter 704 also connected to system bus 708, for providing user interface information to a display 706.

Also connected to system bus 708 are a system memory 710 and an input/output (I/O) bus bridge 712. I/O bus bridge 712 couples an I/O bus 714 to system bus 708, relaying and/or transforming data transactions from one bus to the other. Peripheral devices such as nonvolatile storage 716, which may be a hard disk drive, and input device 718, which may include a conventional mouse, a trackball, or the like, is connected to I/O bus 714.

The exemplary embodiment shown in FIG. 7 is provided solely for the purposes of explaining the invention and those skilled in the art will recognize that numerous variations are possible, both in form and function. For instance, data processing system 700 might also include a compact disk read-only memory (CD-ROM) or digital versatile disk (DVD) drive, a sound card and audio speakers, and numerous other optional components. All such variations are believed to be within the spirit and scope of the present invention.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

The present invention thus uses XML data transformation techniques to allow the dynamic linking of software components based on runtime factors such as environmental conditions (temperature, device status, load), policy (business logic, identity, service level agreements), and other dynamic characteristics of the target platform or host. Such dynamic linking can allow an interface invocation t link to different underlying software components in different manners, based on the dynamic environmental factors of the target platform. When combined with late binding, this will increase the flexibility of software components. Thus, the actual interface binding can then be performed based on environmental conditions, policy, or other dynamic characteristics of the platform or host.

While the invention has been particularly shown and described with reference to a preferred embodiment, it will be understood by those skilled in the art that various changes in form and detail may be made therein without departing from the spirit and scope of the invention. For example, while one preferred embodiment has been described as using the XML-RPC format/protocol, alternatively a Simple Object Access Protocol (SOAP)/Web Services Descriptor Language (WSDL) mechanism can be used with the described XML/XSLT mechanism. (The specification for SOAP, which is herein incorporated by reference in its entirety, is referenced in “W3C Candidate Recommendation—SOAP Message Transmission Optimization Mechanism”, published by W3C on 26 Aug. 2004. The specification for WSDL, which is herein incorporated by reference in its entirety, is reference in “W3C Working Draft—Web Services Descriptor Language (WSDL) Version 2.0, published by W3C on 3 Aug. 2004.) That is, the present invention is particularly useful when working with any RPC mechanism that is based on XML.

What is claimed is:

1. A method comprising:
inputting an Extensible Markup Language (XML) document and an Extensible Style Language (XSL) stylesheet into an Extensible Style Language Transformations (XSLT) processor; and
outputting an output script from the XSLT processor to a target platform based on a dynamic environmental condition of the target platform, the target platform being a combination of hardware and software in a computer system.

2. The method of claim 1, wherein the dynamic environmental condition of the target platform is used to select the XSL stylesheet.

3. The method of claim 1, wherein the dynamic environmental condition of the target platform is entered into the XSLT processor separate from the XSL stylesheet.

4. The method of claim 1, wherein the XSLT processor selects the XSL stylesheet from a plurality of differently formatted XSL stylesheets.

5. The method of claim 4, wherein the differently formatted XSL stylesheets include an XSL stylesheet for IBM Director and an XSL stylesheet for Remote Management and Control (RMC).

6. The method of claim 4, wherein the XSLT processor selects the XSL stylesheet from a plurality of differently formatted XSL stylesheets according to which type of output script is needed by the target platform.

7. The method of claim 6, wherein the needed output script depends on the dynamic environment condition of the target platform.

8. A method comprising:
generating, in a management application, an Extensible Markup Language—Remote Procedure Calling (XML-RPC) source document;
inputting the XML-RPC source document and an Extensible Style Language (XSL) stylesheet into an Extensible Style Language Transformations (XSLT) processor;
outputting an output script from the XSLT processor to a target platform, the target platform being a combination of hardware and software in a computer system, based on an environmental condition of the target platform, the output script being a script capable of invoking a resource manager in a Resource Management and Control (RMC) program;
using the XSLT processor, the output script, and the environmental conditions to generate an XML-RPC response document; and
transmitting the XML-RPC response document to the management application, wherein the XSLT processor is able to use the same environmental conditions to create a feedback response informing the management application as to what action has been taken in the target platform in response to the XML-RPC source document.

9. A method comprising:
inputting a source document into a software code generator; and
outputting software code from the software code generator to a target platform based on an environmental condition of the target platform.

10. The method of claim 9, wherein the environmental condition of the target platform determines which of a plurality of stylesheets is used by the software code generator to generate the outputted software code.

11. The method of claim 9, wherein the software code generator is an Extensible Style Language Transformations (XSLT) processor.

12. The method of claim 11, wherein the software code being outputted from the XSLT processor is a Perl script.

13. The method of claim 11, wherein the software code being outputted from the XSLT processor is a script that is capable of invoking a utility in the target platform.

14. The method of claim 13, wherein the utility is capable of correcting a defect in the target platform.

15. The method of claim 11, wherein the software code being outputted from the XSLT processor is a C Source file.

16. A computer program product, residing on a computer usable medium, comprising:
program code for inputting a source document into a software code generator; and
program code for outputting software code from the software code generator to a target platform based on an environmental condition of the target platform.

17. The computer program product of claim 16, wherein the environmental condition of the target platform determines which of a plurality of stylesheets is used by the software code generator to generate the outputted software code.

18. The computer program product of claim 16, wherein the software code generator is an Extensible Style Language Transformations (XSLT) processor.

19. The computer program product of claim 18, wherein the software code being outputted from the XSLT processor is a script that is capable of invoking a utility in the target platform.

20. The computer program product of claim 19, wherein the utility is capable of correcting a defect in the target platform.

21. A method comprising:
generating, in a management application, a Simple Object Access Protocol/Web Services Description Language (SOAP/WSDL) source document;
inputting the SOAP/WSDL source document and an Extensible Style Language (XSL) stylesheet into an Extensible Style Language Transformations (XSLT) processor;
outputting an output script from the XSLT processor to a target platform, the target platform being a combination of hardware and software in a computer system, based on an environmental condition of the target platform, the output script being a script capable of invoking a resource manager in a Resource Management and Control (RMC) program;
using the XSLT processor, the output script, and the environmental conditions to generate a SOAP/WSDL response document; and
transmitting the SOAP/WSDL response document to the management application, wherein the XSLT processor is able to use the same environmental conditions to create a feedback response informing the management application as to what action has been taken in the target platform in response to the SOAP/WSDL source document.
